(19) United States
(12) Patent Application Publication
(10) Pub. No.: US 2010/0088087 A1
(43) Pub. Date: Apr. 8, 2010

(54) MULTI-TAPABLE PREDICTIVE TEXT

(75) Inventor: Par Spjuth, Sodra Sandby (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/244,020

(22) Filed: Oct. 2, 2008

(51) Int. Cl. G06F 17/27; H04M 3/00

(52) U.S. Cl. 704/9; 455/418

(57) ABSTRACT

A multi-tapable predictive text method and device that allows for both multi-tap and predictive text entry to be used in conjunction thereby facilitating entry of text in languages having a large number or characters and/or on devices having a small number of keys. The method includes selecting at least one set of symbols from a plurality of sets of symbols associated with at least one key of an input device, at least one of the sets of symbols corresponding to at least two alphanumeric characters, and each set of symbols selectable by activating the key a prescribed number of times, analyzing the selected sets of symbols using a predictive text engine to generate a list of potential character strings, and displaying at least one of the potential character strings of the list of character strings for selection by a user.

### TECHNICAL FIELD OF THE INVENTION

The present invention relates generally to electronic devices such as portable communication devices, and, more particularly, to a method and device for text entry on such devices.

### DESCRIPTION OF THE RELATED ART

Contemporary portable devices, including mobile telephones, portable data assistants (PDAs), and other mobile electronic devices typically include embedded email, text messaging, chat, notes, and other text based applications in addition to traditional communication applications—such as mobile telephony.

In each of these applications, text information comprising a combination of alpha numeric characters is input through a user interface of the portable device such as a typical telephone keypad, a full QWERTY miniature keypad, or a touch screen emulating a keyboard.

In contemporary mobile devices the most common user interface configuration comprises keys corresponding to the ten digits “0” through “9” plus additional keys such as “#” and “*”. Each of the keys corresponding to one of the ten digits may also be allocated a number of characters. For example, the key corresponding to the digit “2” is also associated with the characters “A, B, C”.

From a alpha numeric text perspective, this ten digit user interface may be referred as an ambiguous keyboard because the same key is utilized to input each of the digit “2” and letters “A”, “B”, and “C”. As such, to facilitate entry of text information, there are two well known techniques for disambiguating characters typed on such a ten digit keyboard—“multi-tap” and “predictive text”.

In the “multi-tap” system, the user may press each key a number of times depending on the letter that the user wants to enter. For example, when a text based application is active on the portable device, pressing the key corresponding to the digit “2” once gives the character “A”, pressing the key twice gives the character “B” and pressing the key three times gives the character “C”. Usually, there is a predetermined amount of time within which the multiple keys strokes may be entered. This may allow for the key to be re-used for another letter when necessary. Further, pressing the key for a certain period of time usually gives the corresponding number. For instance, in the above example, pressing the key for two seconds may give the digit “2”.

In the “predictive text” system, a predictive text dictionary is used for disambiguating a sequence of key strokes. More specifically, when using a portable device having a predictive text editor, the user may enter a word into a text based application by pressing the keys corresponding to each character of the word exactly once. For example, if the user desires to enter the word “HELLO”, then he or she does this by pressing the keys “4” (which corresponds to ambiguous text input of “G”, “H” or “I”), “3” (which corresponds to ambiguous text input of “D”, “E” or “F”), “5” (which corresponds to ambiguous text input of “J”, “K” or “L”), “5” and “6” (which corresponds to ambiguous text input of “M”, “N” or “O”).

The sequence is referenced to the predictive text dictionary (also referred to as an engine) to disambiguate the sequence of keys pressed by the user into one or more candidate words. In more detail, the dictionary associates frequency of use statistics with various words/key sequences such that candidate words may be chosen—and typically presented to the user as a combination of: i) a “default” word which is the most likely word corresponding to the sequence of keys based on frequency of use; and ii) other candidate words presented in an order of the most likely word corresponding to the sequence of keys to least likely.

If the “default” word is the word desired by the user, the user simply continues typing. If the “default” word is not the word the user desires, the user typically scrolls through a list of the other candidate words to select the desired word. Contemporary portable devices typically include a five way navigation control to facilitate such scrolling and selection by way of moving a cursor or highlight bar on a display screen of the user interface. Predictive text systems may be more desirable than multi-tap systems because of the reduced number of key strokes required to enter a particular word.

While multi-tap and predictive text entry methods have advanced text entry on mobile phones and other devices, in some instances, such as when used in conjunction with languages that have many character or on devices having few keys, the number of characters associated with each key is large such that either (i) multi-tap text entry becomes overly cumbersome as a large number of taps may be required to select a single letter, or (ii) the large number of characters associated with each key results in a large list of possible words generated by the predictive text engine such that a user cannot quickly select the desired word.

### SUMMARY

To improve the functionality of portable communication devices and facilitate more accurate and efficient text entry, aspects of the invention are directed to a multi-tapable predictive text method and device that allows for both multi-tap and predictive text entry to be used in conjunction thereby facilitating entry of text in languages having a large number or characters and/or on devices having a small number of keys.

According to one aspect of the invention, there is provided a method for entering information in an electronic equipment, the method comprising selecting at least one set of symbols from a plurality of sets of symbols associated with at least one key of an input device, at least one of the sets of symbols corresponding to at least two alphanumeric characters, and each set of symbols selectable by activating the key a prescribed number of times, analyzing the selected sets of symbols using a predictive text engine to generate a list of potential character strings, and displaying at least one of the potential character strings of the list of character strings for selection by a user.

According to another aspect, the method further comprises, upon selection of a set of symbols associated with a key, displaying the selected set of symbols on a display of the electronic equipment.

According to another aspect, the method further comprises upon a first activation of a key, displaying on a display of the electronic equipment at least one set of symbols associated with a key.

According to another aspect, the method further comprises upon a first activation of a key, displaying on a display of the electronic equipment the sets of symbols associated with the key, and upon selection of a set of symbols, highlighting the selected set.

According to another aspect, the method the selecting at least one set of symbols includes selecting at least one set of symbols from a plurality of keys each having a plurality of sets of symbols associated therewith.

According to another aspect of the invention, an electronic equipment comprises an input device for allowing a user to enter information, the input device including at least one key having a plurality of sets of symbols associated therewith, at least one of the sets of symbols corresponding to at least two alphanumeric characters, and each set of symbols selectable by activating the key a prescribed number of times, a multi-tap detector for determining what set of symbols is selected based on the number of key activations, and a predictive text generator for receiving at least one set of symbols from the multi-tap detector and generating a list of potential character strings for selection by a user.

According to another aspect, the electronic equipment further comprises a display for displaying the list of potential character strings for selection by a user.

According to another aspect, the electronic equipment further comprises a display for displaying the selected set of symbols upon selection of same.

According to another aspect, the electronic equipment further comprises a display for displaying, upon a first activation of a key, at least one set of symbols associated with the key.

According to another aspect, the electronic equipment further comprises a display for displaying, upon a first activation of a key, the sets of symbols associated with the key, and upon selection of a set of symbols, highlighting the selected set.

According to another aspect, the electronic equipment is a mobile phone.

According to another aspect, the electronic equipment is at least one of a personal audio device, a personal video device or a personal digital assistant.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic equipment in accordance with an embodiment of the present invention.

FIG. 2 is a schematic block diagram of the relevant portions of the mobile telephone of FIG. 1 in accordance with an embodiment of the present invention.

FIG. 3 is a schematic block diagram illustrating an exemplary multi-tapable predictive text system in accordance with the invention.

FIG. 4 is a schematic illustration of a several exemplary keypads in accordance with the invention.

FIG. 5 is a schematic illustration of another exemplary keypad in accordance with the invention.

FIG. 6 is an exemplary screen of an electronic device implementing the multi-tapable predictive text system in accordance with the invention

### DETAILED DESCRIPTION OF THE EMBODIMENTS

The term “electronic equipment” includes portable radio communication equipment. The term “portable radio communication equipment,” which herein after is referred to as a “mobile radio terminal,” “mobile phone,” “mobile device,” or “mobile terminal”, and the like, includes all equipment such as mobile telephones, pagers, communicators, i.e., electronic organizers, personal digital assistants (PDAs), smartphones, portable communication apparatus or the like. The term “communication device” includes electronic equipment, as well as telephones, such as VoIP based wire line telephones and conventional wire line telephones. The term “communication” includes voice communications (both live and pre-recorded), text messages, and email messages (including attachments such as music and videos).

In the present application, the invention is described primarily in the context of a mobile telephone. However, it will be appreciated that the invention is not intended to be limited to a mobile telephone and can be any type of communication device. The present invention will now be described with reference to the drawings, wherein like reference numerals are used to refer to like elements throughout.

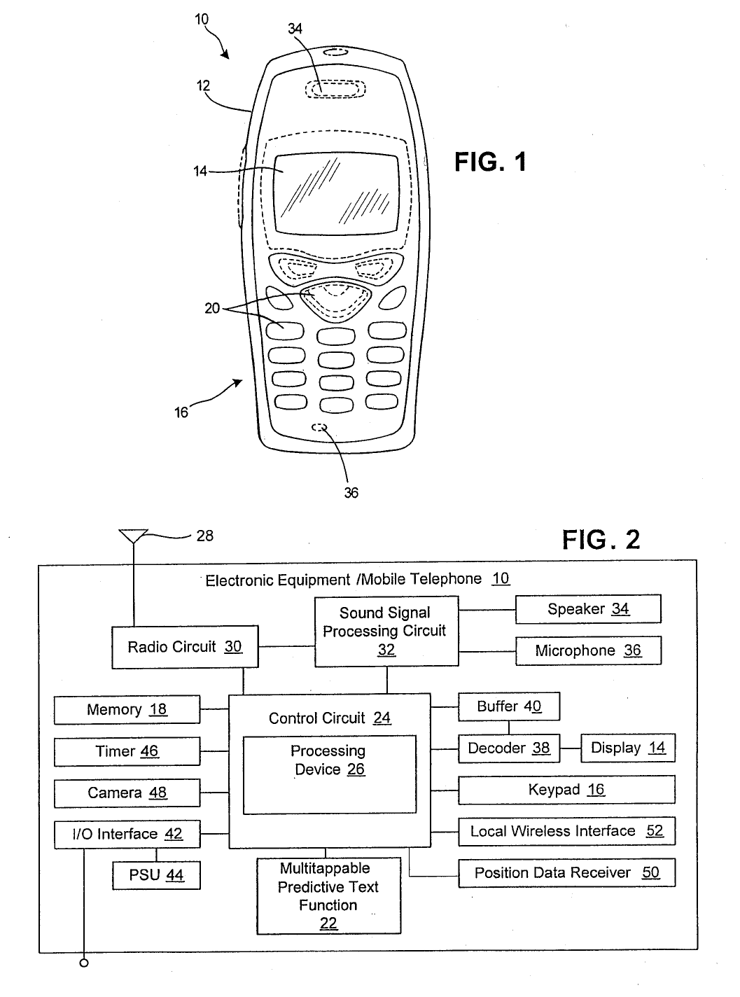

Referring initially to FIG. 1, an electronic equipment 10 is shown in accordance with the present invention. The electronic equipment includes a multi-tapable predictive text function that is configured to allow both multi-tap and predictive text entry. The multi-tapable predictive text function enables a larger number of characters to be assigned to each button of the keypad while maintaining the efficiency and functionality of text entry. It will be appreciated that the multi-tapable predictive text function may be embodied as executable code that may be resident in and executed by the electronic equipment 10.

The electronic equipment in the exemplary embodiment is a mobile telephone and will be referred to as the mobile telephone 10. The mobile telephone 10 is shown as having a “brick” or “block” form factor housing 12, but it will be appreciated that other types of housings, such as a clamshell housing or a slide-type housing, may be utilized without departing from the scope of the invention.

The mobile telephone 10 includes a display 14 and keypad 16. As is conventional, the display 14 displays information to a user such as operating state, time, telephone numbers, contact information, various navigational menus, etc., which enable the user to utilize the various features of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or land line/wire line telephone. However, the called/calling device need not be another telephone, but may be some other device such as an Internet web server, content providing server, etc.

FIG. 2 represents a functional block diagram of the mobile telephone 10. With the exception of a multi-tapable predictive text function 22, which is preferably implemented as executable logic in the form of application software or code within the mobile telephone 10, the construction of the mobile telephone 10 is otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out conventional operation of the mobile telephone 10. The memory 18 may be, for example, one or more of a buffer, a flash memory, a hard drive, a removable media, a volatile memory, a non-volatile memory or other suitable device. In addition, the processing device 26 executes code in order to perform the communication rerouting function 22.

It will be apparent to a person having ordinary skill in the art of computer programming, and specifically in applications programming for mobile telephones or other items of electronic equipment, how to program a mobile telephone 10 to operate and carry out the functions described herein. Accordingly, details as to the specific programming code have been left out for sake of brevity. Also, while the multi-tapable predictive text function 22 is executed by the processing device 26 in accordance with the preferred embodiment of the invention, such functionality could also be carried out via dedicated hardware, firmware, software, or combinations thereof, without departing from the scope of the invention. Any of these implementations may be referred to as a communication rerouting circuit.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system, as well as to receive audiovisual content. For example, the receiver may be an IP datacast compatible receiver compatible with a hybrid network structure providing mobile communications and DVB-H based or similar services. Other receivers for interaction with a mobile radio network or broadcasting network are possible and include, for example, GSM, CDMA, WCDMA, MBMS, WiFi, WiMax, DVB-H, ISDB-T, etc.

The mobile telephone 10 further includes a sound signal processing circuit 32 for processing audio signals transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. The display 14 may be coupled to the control circuit 24 by a video decoder 38 that converts video data to a video signal used to drive the display 14. The video data may be generated by the control circuit 24, retrieved from a video file that is stored in the memory 18 or derived from an incoming video data stream received by the radio circuit 30. Prior to being fed to the decoder 38, the video data may be buffered in a buffer 40.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown). Further, the I/O interface(s) 42 may serve to connect the mobile telephone 10 to a personal computer or other device via a data cable. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include timing the durations of calls, generating the content of time and date stamps, etc. The mobile telephone 10 may include a camera 48 for taking digital pictures and/or movies. Image and/or video files corresponding to the pictures and/or movies may be stored in the memory 18. The mobile telephone 10 also may include a position data receiver 50, such as a global positioning system (GPS) receiver, Galileo satellite system receiver or the like. The mobile telephone 10 also may include a local wireless interface 52, such as an infrared transceiver and/or an RF adaptor (e.g., a Bluetooth adapter), for establishing communication with an accessory, hands-free adaptor, another mobile radio terminal, computer or other device.

The mobile telephone 10 may be configured to transmit, receive and process data, such as text messages (e.g., a short message service (SMS) formatted message), electronic mail messages, multimedia messages (e.g., a multimedia messaging service (MMS) formatted message), image files, video files, audio files, ring tones, streaming audio, streaming video and so forth. Processing such data may include storing the data in the memory 18, executing applications to allow user interaction with data, displaying video and/or image content associated with the data, broadcasting audio sounds associated with the data and so forth.

As is conventional, the mobile telephone 10 may be configured to operate as part of a communications system. The system may include a communications network having a server (or servers) for managing calls placed by and destined to the mobile telephone 10, transmitting data to the mobile telephone 10 and carrying out any other support functions. The server communicates with the mobile telephone 10 via a transmission medium. The transmission medium may be any appropriate device or assembly, including, for example, a communications tower, another mobile telephone, a wireless access point, a satellite, etc. Portions of the network may include wireless transmission pathways.

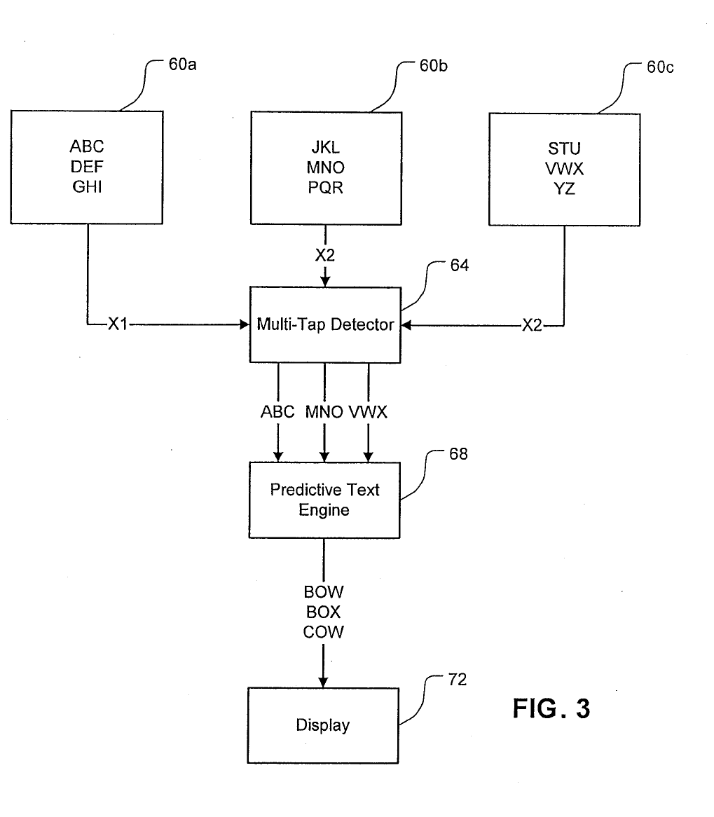

Moving now to FIGS. 3-6, and initially to FIG. 3, several exemplary implementations of communication devices and/or systems implementing the multi-tapable predictive text function 22 will be described. In the schematic illustration in FIG. 3, three keys 60a, 60b, and 60c are illustrated each having three sets of symbols associated therewith. In the illustrated embodiment, the symbols correspond to the characters of the English alphabet, and each key 60a, 60b, and 60c has associated therewith three sets of three characters (except the third set of key 60c has only two characters). It will be appreciated that the symbols can be virtually any conceivable symbol, such as characters of any language or strokes for assembling Chinese character, for example. Another type of symbol may in fact be a plurality of symbols, such as for forming what is commonly referred to as an emoticon (e.g., a smiley face typically formed by a colon combined with an ellipse :)).

Activation of each key 60a, 60b, and 60c is monitored by a multi-tap detector 64 that determines which set of symbols a user is selecting based on the number of times a key is activated. As will be appreciated, conventional methods of detecting a multi-tap condition and selecting the corresponding set of symbols can be employed. For example, the multi-tap detector 64 may typically examine a time interval between consecutive activations of a key to determine whether a user intends the first, second, or third set of symbols to be selected. Thus, the multi-tap detector 64 may be configured to measure a time interval between consecutive same key activations and compare it to a prescribed time interval. If the measured time interval is less than the prescribed time interval, then the multi-tap detector determines that the user is attempting to select one of the second and/or third set of symbols. If the measured time is greater than the prescribed time, then the multi-tap detector 64 determines that the user intends to select the current set of symbols.

Once a set of symbols is selected, the multi-tap detector 64 sends the set of symbols to a predictive text engine 68. In the illustrated embodiment, key 60a is activated one time and the multi-tap detector 64 thus sends the character set “A, B, C” to the predictive text engine 68. Key 60b is activated two times, and accordingly the multi-tap detector 64 sends character set “M, N, O” to the predictive text engine 68. Finally, key 60c is activated one time, and the multi-tap detector 64 sends character set “V, W, X” to the predictive text engine 68.

As the predictive text engine 68 receives the set or sets of symbols from the multi-tap detector 64, a list of potential character strings is generated. In this case, based upon the order the sets of symbols were received by the predictive text engine 68 and the characters in each set, the generated list of words includes: BOW, BOX, COW. This list is then displayed on a display 72 for selection of the desired word by the user. As will be appreciated, any suitable predictive text technology can be used to generate the list of potential character strings.

The foregoing example described in connection with FIG. 3 illustrates how features of the invention facilitate text entry on a device having only three keys 60a, 60b, and 60c. On some electronic devices this can be a beneficial, especially on devices where space for buttons is limited, for example.

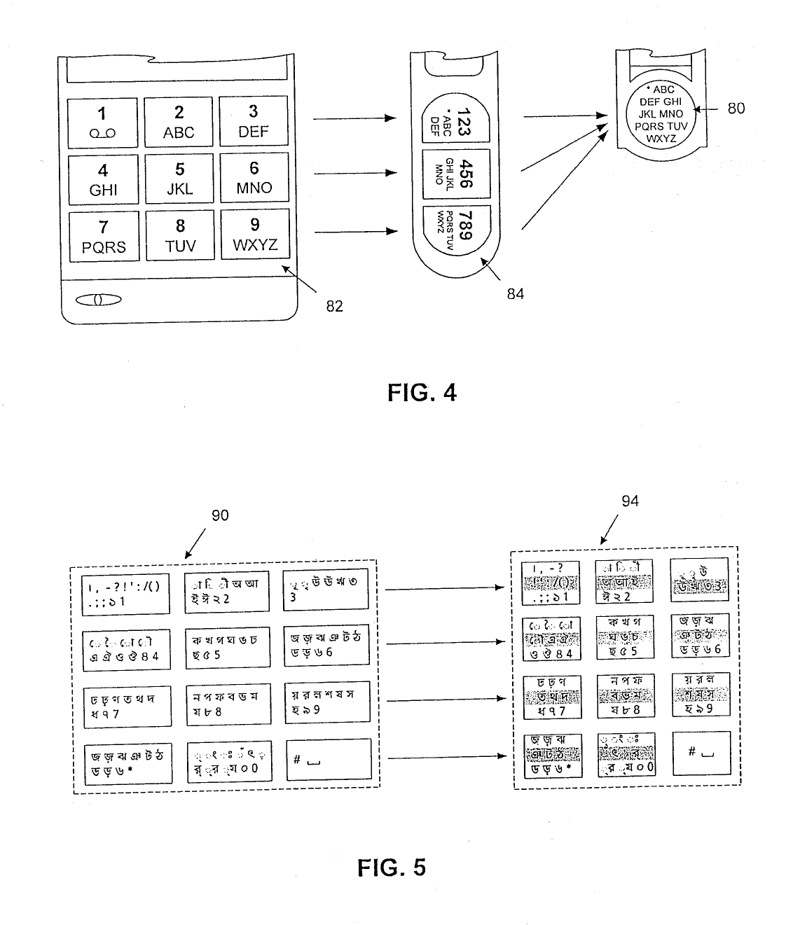

With reference to FIG. 4, it will be understood that features of the invention may facilitate text entry with only a single key 80. In FIG. 4, it is seen how a typical 9-key keypad 82 (left) can be embodied in a 3-key keypad 84 (center) as just described, and further in the 1-key keypad 80 (right). As will be appreciated, in the case of the 1-key keypad, for each letter of a word a user desires to type, the user will activate the key 80 a certain number of times such that the multi-tap detector 64 sends a desired set of symbols containing each respective letter of the word to the predictive text generator 68. While it is generally true that, for a given word, a system having fewer keys will require more key strokes than a system having more keys, it will be appreciated that the 1-key embodiment will still likely result in fewer key strokes than a 1-key multi-tap only system, for example.

Turning to FIG. 5, it will be readily apparent that aspects of the invention are particularly useful when dealing with languages having a large number of characters. In this example, keypad 90 has a total of 110 alphanumeric characters divided amongst twelve keys. In a multi-tap only system, entry of text is no doubt cumbersome, having to tap a single key up to nine times to select a single character.

In accordance with the invention, keypad 94 has twelve keys like keypad 90, but the characters on each key are split into sets in the manner described above. Thus, a user need only activate each key three times at most to select the set of characters that includes the desired character, in accordance with the process described above. Thus, by selecting smaller sets of characters than would otherwise be present on each key, it will be appreciated that the number of predicted words generated by the predictive text engine is reduced dramatically, making it much more likely that the user finds the desired word without having to resort to a multitude of key presses going through the list.

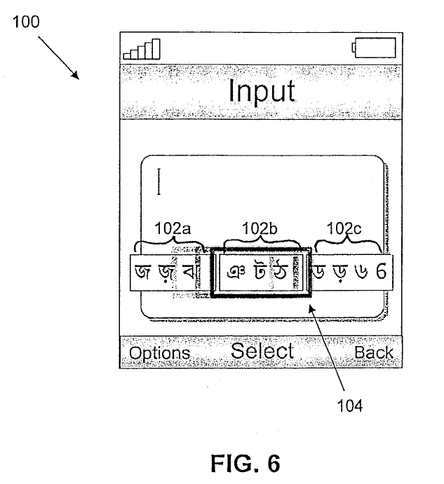

In any of the above-described embodiments, during selection of a set of symbols through the multi-tap process it may be useful to indicate to the user which set of symbols is being selected. Referring to FIG. 6, a display 100 is illustrated having three sets of symbols 102a, 102b, and 102c overlayed thereon. The sets of symbols 102a, 102b, and 102c may be associated with any of the keys of a corresponding keypad, and the electronic device can be configured to overlay all three sets on the screen 100 upon the first activation of a key. A rectangular box 104 surrounds the currently selected set of symbols, which in this case is set 102b. Thus, a user is provided with visual feedback regarding which set of symbols is currently selected, and then may either actively select that set of symbols such as by depressing a directional pad, for example, or the user may simply wait the prescribed period of time until the multi-tap detector determines that the user intends to select set 102b.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method for entering information in an electronic equipment, the method comprising:
selecting at least one set of symbols from a plurality of sets of symbols associated with at least one key of an input device, at least one of the sets of symbols corresponding to at least two alphanumeric characters, and each set of symbols selectable by activating the key a prescribed number of times;
analyzing the selected sets of symbols using a predictive text engine to generate a list of potential character strings; and
displaying at least one of the potential character strings of the list of character strings for selection by a user.

2. A method as set forth in claim 1, further comprising, upon selection of a set of symbols associated with a key, displaying the selected set of symbols on a display of the electronic equipment.

3. A method as set forth in claim 1, further comprising upon a first activation of a key, displaying on a display of the electronic equipment at least one set of symbols associated with a key.

4. A method as set forth in claim 1, further comprising upon a first activation of a key, displaying on a display of the electronic equipment the sets of symbols associated with the key, and upon selection of a set of symbols, highlighting the selected set.

5. A method as set forth in claim 1, wherein the selecting at least one set of symbols includes selecting at least one set of symbols from a plurality of keys each having a plurality of sets of symbols associated therewith.

6. An electronic equipment comprising:
an input device for allowing a user to enter information, the input device including at least one key having a plurality of sets of symbols associated therewith, at least one of the sets of symbols corresponding to at least two alphanumeric characters, and each set of symbols selectable by activating the key a prescribed number of times;
a multi-tap detector for determining what set of symbols is selected based on the number of key activations; and
a predictive text generator for receiving at least one set of symbols from the multi-tap detector and generating a list of potential character strings for selection by a user.

7. An electronic equipment as set forth in claim 6, further comprising a display for displaying the list of potential character strings for selection by a user.

8. An electronic equipment as set forth in claim 6, further comprising a display for displaying the selected set of symbols upon selection of same.

9. An electronic equipment as set forth in claim 6, further comprising a display for displaying, upon a first activation of a key, at least one set of symbols associated with the key.

10. An electronic equipment as set forth in claim 6, further comprising a display for displaying, upon a first activation of a key, the sets of symbols associated with the key, and upon selection of a set of symbols, highlighting the selected set.

11. An electronic equipment as set forth in claim 6, wherein the electronic equipment is a mobile phone.

12. An electronic equipment as set forth in claim 6, wherein the electronic equipment is at least one of a personal audio device, a personal video device or a personal digital assistant.
